(19) United States
(12) Patent Application Publication
(10) Pub. No.: US 2006/0248008 A1
(43) Pub. Date: Nov. 2, 2006

(54) Method of evaluating a benefit plan

(75) Inventor: David P. Lind, West Des Moines, IA (US)

Correspondence Address: ZARLEY LAW FIRM P.L.C., CAPITAL SQUARE, 400 LOCUST, SUITE 200, DES MOINES, IA, 50309-2350, US

(73) Assignee: David P. Lind & Associates, L.C., Clive, IA (US)

(21) Appl. No.: 11/117,582

(22) Filed: Apr. 27, 2005

(51) Int. Cl. G06Q 40/00

(52) U.S. Cl. 705/40

(57) ABSTRACT

A method of evaluating a benefit plan where a user selects the benefits from a present plan, provides detailed information on the selected benefits, compares the detailed information with the pre-existing information, and generates a report based on the comparison.

### BACKGROUND OF THE INVENTION

This invention is directed toward a method of evaluating a benefit plan, and more specifically to a method of comparing a present benefit plan with pre-existing benefit information.

According to the U.S. Department of Labor, it costs a company ⅓ of a new hire's annual salary to replace an employee. Thirty-two percent of top-performing employees cited dissatisfaction with benefits as being a significant factor in leaving an organization. Thus, the benefits offered by an organization are critical in helping an organization establish and maintain competitiveness in the marketplace. By providing a competitive array of employee benefits an employer can greatly impact employee attraction, retention, loyalty, morale, and productivity which ties directly to the overall success of a company.

Determining and evaluating the competitiveness of an employer's benefit plan as compared to other employers is an important step in the process. Presently, employer benefit information is available via surveys at cost which allows an employer to manually compare a present benefit plan with the surveys. This comparison is labor intensive, time consuming, and sometimes expensive. This comparison can also be performed by outside consultants which is also generally expensive. Therefore, there is a need in the industry for a better way for a company to gauge the competitiveness of its benefit plan against other employers.

A principal objective of the present invention is to provide a method of evaluating a benefit plan that is easy to perform.

A further objective of the present invention is to provide a method of evaluating a benefit plan that is inexpensive to perform.

A still further objective of the present invention is to provide a method of evaluating a benefit plan that quickly provides a comparison with other employers.

These and other objectives will be apparent to those skilled in the art based on the following description.

### SUMMARY OF THE INVENTION

A method of evaluating a benefit plan where an employer identifies benefits presently being offered and provides detailed information on the identified benefits. The detailed identified benefits are then compared with pre-existing benefit information from other employers and the results of the comparison are published allowing the employer to analyze, evaluate, and adjust its present benefit plan.

### BRIEF DESCRIPTION OF THE DRAWINGS

FIG. 1 is a schematic block diagram of a computer system for evaluating a benefit plan;

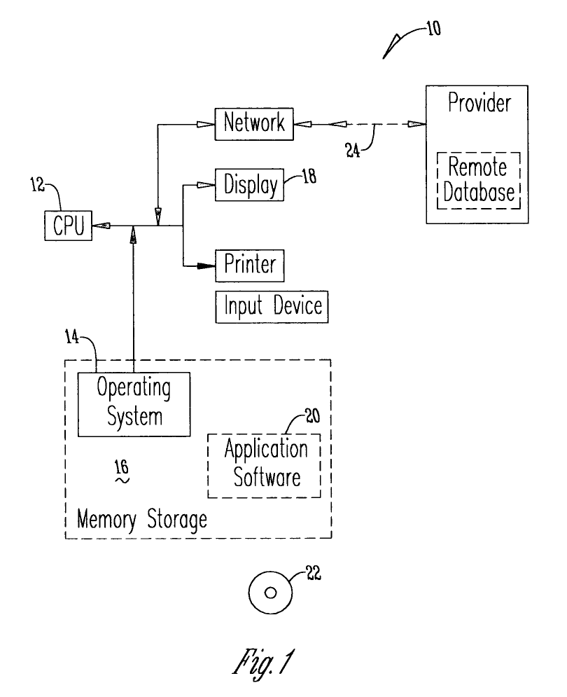

FIG. 2 is a flow chart of a method of evaluating a benefit plan; and

FIG. 3 is a chart comparing user benefits with overall industry standards.

### DETAILED DESCRIPTION OF THE PREFERRED EMBODIMENTS

A method for evaluating a benefit plan preferably performed with the aid of a computer 10 having a central processing unit (CPU) 12, associated with a general purpose computer operating system 14, a memory storage device 16 for the CPU, and a pixel-oriented display device 18. The method is performed via application software 20 that is stored on a disc 22, the hard drive of the operating system 14, or preferably accessed via an internet connection 24. For purposes of example only, the method will be described as performed through accessing a providers website 26 via an internet connection 24.

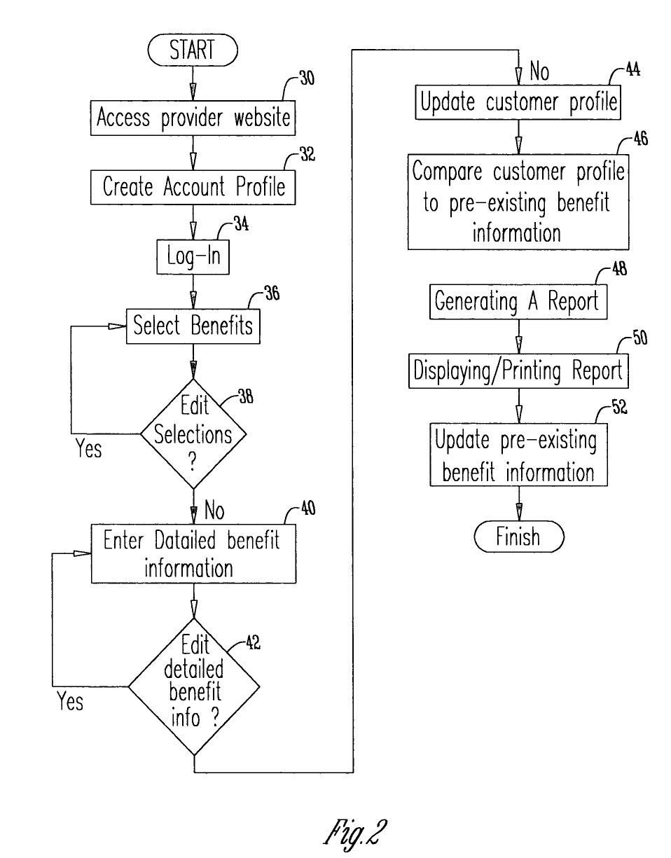

FIG. 2 shows a process by which a user may evaluate a benefit plan. The process begins at step 30 where a user accesses a provider's website 26 via an internet connection. At step 32, the user is prompted to create an account. As an example, the user is asked to input information such as their name, company, address, phone number, e-mail address, industry, company size, and credit card, debit card, bank account or other type of payment information. Once payment is made and authorized the user is provided with an access code that will allow the user to log-on and a customer profile is created and stored in the provider's database. The access code is provided to the user directly via the provider's website 26 and/or via an e-mail transmission. The user and/or provider may protect the access code with a password or similar type of security means that is stored by the provider's customer profile database 27.

At step 34, the user logs in by entering the access code and when appropriate the password. The system will compare the access code with the provider's customer database 27 and the user will be given access to the application provided there is a match. The user may log off at any time and return to the application at the point last saved by logging in again. Once access is provided, as set forth in step 36, the user is prompted to select benefits that are presently being offered by the user. As an example, the user is prompted to select from a group of benefits such as health insurance, dental insurance, retirement plan, basic life insurance, supplemental life insurance, dependent life insurance, short term disability insurance, long term disability insurance, vision insurance/discount programs, company paid holidays, sick leave, vacation, paid time off (P.T.O.), Section 125 POP Plan, Retiree health insurance (65+), Long Term Care insurance, employee assistance program (EAP), Educational Tuition Reimbursement, casual dress, flextime, telecommuting, child care assistance (on or off site), and fitness center/gym subsidy. Once selected, the user is prompted at decisional step 38 whether the user wishes to edit any of the benefit selections. If the user wishes to edit the benefits selected then the YES branch of decisional step 38 returns to step 36 where the user may alter the benefits selected. When the user does not wish to edit the benefits selected, the NO branch of decisional step 38 leads to step 40.

At step 40, the user is prompted to enter detailed information on benefits based on the selection of benefits made in step 36. As an example, if the user had selected health insurance the user would be prompted to identify the types of health plans offered (i.e., PPO, HMO/POS or traditional indemnity), the number of employees enrolled in each plan, the monthly billed health insurance rates for both single and family enrollment, the monthly employee contribution for both single and family enrollment, and similar information related to health insurance benefits. Similar prompts requesting the user to identify detailed information for selected benefits are provided where the user will input details on each selected benefit.

Once completed, the user is prompted at decisional step 42, whether the user wishes to edit any of the detailed information entered in step 40. If the user wishes to edit the detailed information, the YES branch of decisional step 42 returns to step 40 where the user may alter the detailed information previously entered. When the user does not wish to edit the benefits selected, the NO branch of decisional step 42 leads to step 44.

At this point, step 44, the customer's profile stored in the provider's database is updated to include the detailed benefit information provided by the user.

Once updated, at step 46, the user's customer profile is compared with the provider's pre-existing database of benefit information. Preferably, the pre-existing database is based on a series of annual studies that measure a statistically valid sample of urban and rural employers of different size, industry, and geographic location.

The comparison is preferably performed by the application software 20 on the provider's operating system 14. An example of the type of information compared include the average monthly insurance premiums paid by employees for health and dental insurance; average monthly employee and family contributions for health and dental insurance coverage; deductibles, co-payments for office visits and prescription drugs, and out-of-pocket maximums; traditional leave and paid time off (PTO) components (i.e., vacation, sick leave, personal days and company holidays); cost sharing between employer and employees of short and long term disability plans; most common group life benefit coverage; and most common employer match on defined contribution retirement plans.

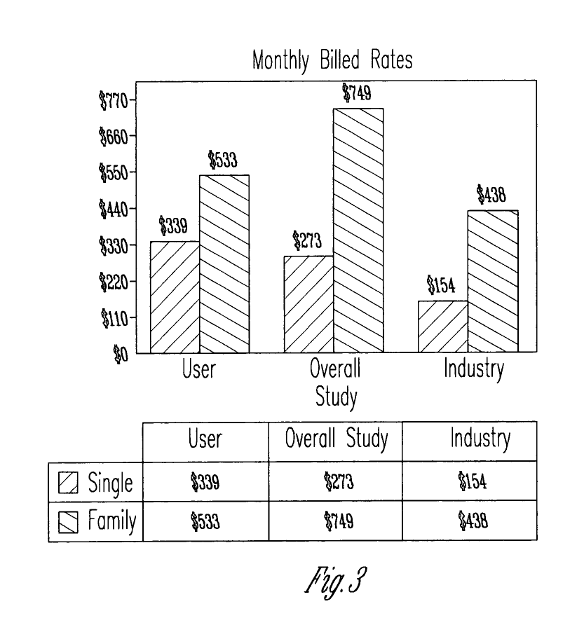

Once the updated client profile is compared to the pre-existing benefit information at step 46, a report is generated based on the comparison at step 48. Preferably the report provides historical information on benefits offered over a desired time period and benefit information for all companies as well as separated by company size, geographic location, and industry. This information preferably is provided in text graph, and chart form. The report is also preferably customized to include text that provides specific observations on how the user's plan compares to pre-existing information. For example, a graph, as shown in FIG. 3 would provide a graphical comparison of how the user's monthly billed rates for healthcare compare to the overall survey and to the user's particular industry. Following the graph would be text advising the user that its single rates for health insurance are, for example, 24.4% higher than the overall company average, and, as an example 120.7% higher than other employers in the user's industry. Similar text regarding the comparisons made would be provided for all benefits selected by the user.

Once the report is generated at step 48, the report is displayed at step 50. The report is displayed on the display device and/or transferred to a printer so the user may have a hard copy of the report.

As an alternative, once the report is displayed, the provider's database of pre-existing benefit information may be updated by incorporating information from the user's updated customer profile at step 52.

From this description a method of evaluating a benefit plan has been shown that is easy and inexpensive to perform and allows a user to gauge the competitiveness of its present plan.

What is claimed is:

1. A method of evaluating a benefit plan using a computer, comprising:
selecting benefits from a present benefit plan;
providing detailed information on the selected benefits;
comparing the detailed information with pre-existing benefit information; and
generating a report based on the comparison of the detailed information with the pre-existing benefit information.

2. The method of claim 1 further comprising the step of creating a client profile.

3. The method of claim 2 further comprising the step of updating the client profile with the detailed information.

4. The method of claim 3 further comprising the step of updating the pre-existing benefit information with the updated client profile.

5. The method of claim 1 further comprising the step of displaying the generated report.

6. The method of claim 1 wherein the generated report includes customized text based on the comparison.

7. The method of claim 1 wherein the generated report separates compared data based on company size, geographic location, and industry.

8. The method of claim 1 wherein the generated report provides historical information on benefits.
